(19) United States
(12) Patent Application Publication
(10) Pub. No.: US 2006/0291453 A1
(43) Pub. Date: Dec. 28, 2006

(54) Facsimile server and method of controlling the same

(75) Inventor: Tetsuya Kuwahara, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/475,164

(22) Filed: Jun. 27, 2006

(30) Foreign Application Priority Data
Jun. 28, 2005 (JP) 2005-187530

(51) Int. Cl. H04L 12/66

(52) U.S. Cl. 370/352

(57) ABSTRACT

When a request for an HTTP connection is made from a PC to a facsimile server, the facsimile server determines whether or not the login PC is located within the same segment as the facsimile server. When a determination is made that the login PC is located within the same segment, the facsimile server performs a requested HTTP processing. When a determination is made that the login PC is not located within the same segment, the facsimile server requests an entry of a password. Only when the entered user name and password correspond with a user name and a password registered in the facsimile server, the facsimile server performs the requested HTTP processing.

### BACKGROUND OF THE INVENTION

1. Field of the Invention

The present invention relates to a facsimile server connected with a terminal device such as a Personal Computer (PC) via a communication network such as a Local Area Network (LAN).

2. Description of the Related Art

In recent years, facsimile systems have spread in offices and other similar environments. The facsimile systems play advantageous roles in data communications in the offices and other environments. Such a system is configured to include a facsimile server and a so-called client PC, such as a terminal device, connected, for example, by a communication network such as a LAN. When data is received via facsimile, the facsimile server transfers the data to the client PC. Furthermore, when data having a designated transfer destination is received from the client PC, the facsimile server sends the received data to the designated transfer destination.

Such a facsimile server is equipped with a network board having a web server function. When receiving a facsimile or an electronic mail (e-mail), document management is performed by storing the received document in a personal folder or a shared folder within the network board in accordance with a delivery setting. The user can fetch the stored document from the client PC by making access to a storage location in the network board where the document is stored.

In such a facsimile system, a system administrator can be registered, and a device setting can be performed from a browser of a terminal device (a PC). To prevent a person other than the system administrator from altering the device setting or viewing registered items, authentication is performed with an Internet Protocol (IP) address or a password in order to limit the access.

In the above-described conventional facsimile server, the authentication is performed with the IP address or the password in order to limit the access. There is a problem that this process is cumbersome because a password must be set, maintained, and managed. Furthermore, it has been necessary to provide security against acquisition of the device information from the outside. Nonetheless, the device is required to provide easy controllability. Therefore, there is a demand for a method of simplifying the access.

On the other hand, in case of a security system using a password, there is a problem that if a password registered with a device is known to a third party, the third party can easily acquire the device information.

### SUMMARY OF THE INVENTION

In view of the foregoing problems, an advantage of the present invention is to provide a facsimile server which can easily perform authentication management and can prevent unauthorized access using a password.

According to a preferred aspect of the present invention, a facsimile server includes a connection unit and a control unit. The connection unit establishes a connection with a terminal device via a communication network. When a terminal device located in the same segment as the facsimile server logs into the facsimile server, the control unit does not perform a password authentication. When a terminal device outside the same segment logs in, the control unit performs the password authentication.

According to another preferred aspect of the present invention, a facsimile server includes a connection unit, a password storage unit, and a control unit. The connection unit establishes a connection with a terminal device via a communication network. The password storage unit stores a password and an expiration date of the password. When a terminal device logs in, the control unit invalidates an expired password.

According to another preferred aspect of the present invention, when all the passwords stored in the password storage unit have expired, the control unit carries out a notification of such a fact.

According to the above-described facsimile server, if an access is made from a terminal device within the same segment where the facsimile server is located, no password is necessary. However, if an access is made from a terminal device not located in the same segment, an entry of a password is requested. Furthermore, the facsimile server determines whether a presently entered password agrees with any one of the passwords registered in the facsimile server. Consequently, security can be secured by simple authentication management.

In addition, any access using an expired password is invalidated. Therefore, even if a password is known to a third party, access can be inhibited after the password has expired. In consequence, the security can be enhanced.

In addition, when all of the passwords have expired, such a fact is notified to the system administrator or a user. Consequently, the administrator or the user can easily recognize that a new password should be set.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates one example of a network configuration of a system including a digital Multi Function Peripheral (MFP) employing a facsimile server according to a preferred embodiment of the present invention.

FIG. 2 is a block diagram illustrating a hardware configuration of the digital MFP.

FIG. 3 illustrates one example of a delivery setting table.

FIG. 4 is a functional block diagram illustrating functions of a network board.

FIG. 5 illustrates a concept of a document management unit in the network board.

FIG. 6 illustrates one example of a password table.

FIG. 7 illustrates one example of a document list display screen.

FIG. 8 illustrates one example of an optional function selection screen.

FIG. 9 illustrates one example of a remote connection setting screen.

FIG. 10 is a flowchart illustrating operations performed when registering or altering a setting of a digital MFP.

FIG. 11 illustrates one example of a password entry screen.

FIG. 12 illustrates one example of a password table according to another preferred embodiment of the invention.

FIG. 13 is a flowchart illustrating operations performed when registering or altering a setting of a digital MFP according to another preferred embodiment of the present invention.

FIG. 14 is a flowchart illustrating operations performed when notifying an elapse of an expiration date.

### DESCRIPTION OF THE PREFERRED EMBODIMENTS

### First Preferred Embodiment

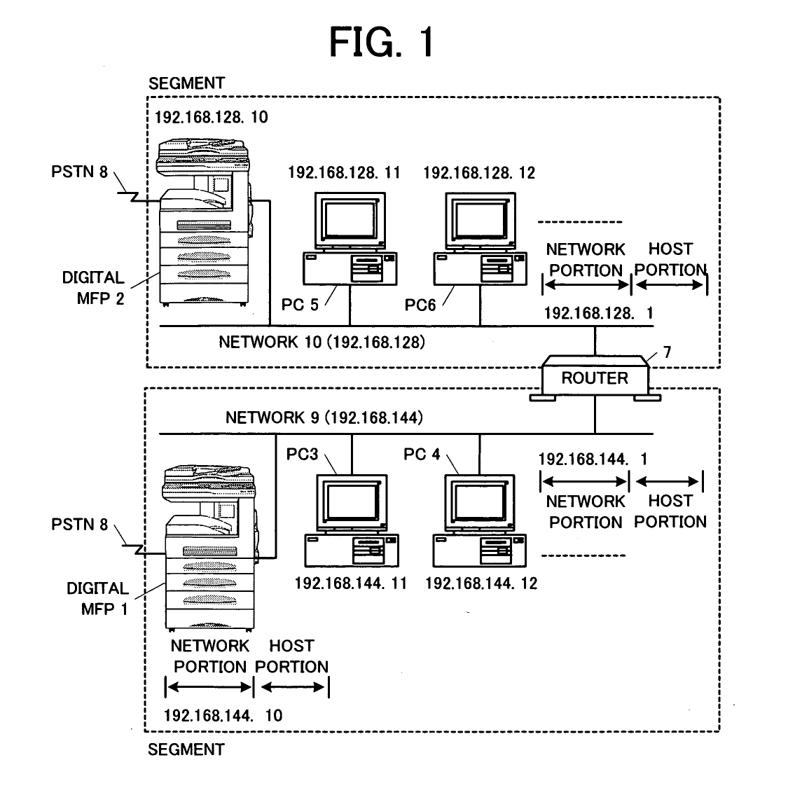

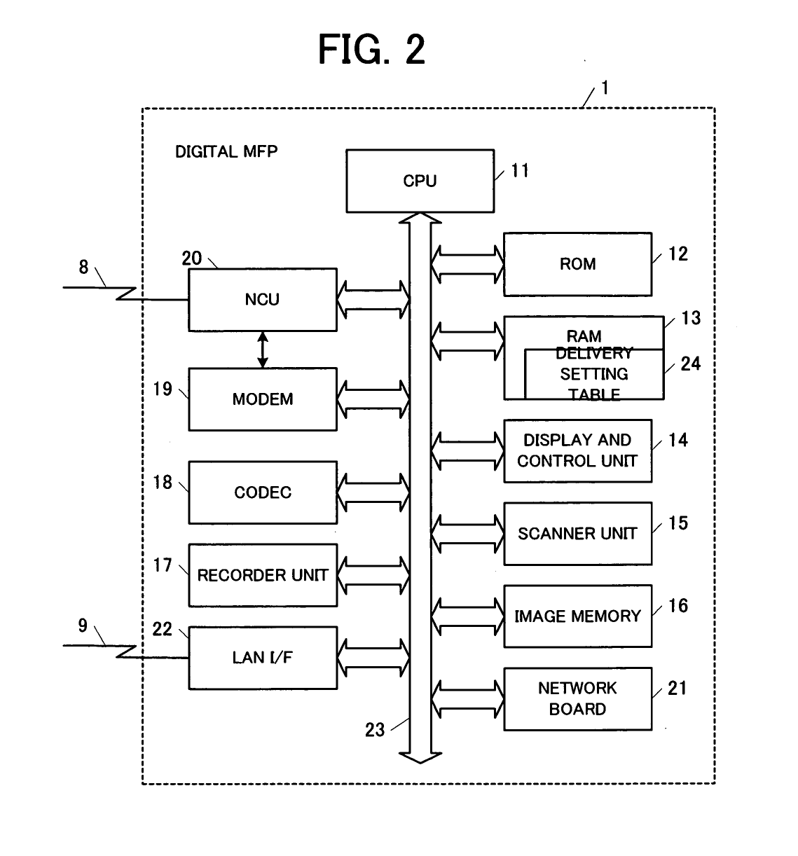

A preferred embodiment of the present invention in which a facsimile server is applied to a digital MFP is hereinafter described with reference to the drawings. FIG. 1 illustrates an example of a network configuration of a system including a digital MFP. FIG. 2 is a block diagram illustrating a hardware configuration of the digital MFP.

The network configuration illustrated in FIG. 1 includes digital MFPs 1 and 2, PCs 3, 4, 5, 6, etc., a router 7, a Public Switched Telephone Network (PSTN) 8, and networks 9 and 10. The digital MFP 1, the PCs 3 and 4, etc. are connected with the network 9 of “192.168.144” within the same segment. The digital MFP 2, the PCs 5 and 6, etc. are connected with the network 10 of “192.168.128” within the same segment. The networks 9 and 10 are in different segments. The router 7 is connected with both networks 9 and 10, and determines a route by examining a network portion of a destination IP address of received data.

An IP address includes a network portion and a host portion. The network portion of the IP address of the devices within the same segment is set to the same value. Within the same segment, the host portion of the IP addresses must not be set to the same value. Accordingly, the IP address of the digital MFP land the PCs 3 and 4 is set to “192.168.144.10”, “192.168.144.11”, and “192.168.144.12”, respectively. The IP address of the digital MFP 2 and the PCs 5 and 6 is set to “192.168.128.10”, “192.168.128.11”, and “192.168.128.12”, respectively.

Meanwhile, each of the digital MFPs 1 and 2 has various functions such as copy mode, print mode, and facsimile mode. Each of the digital MFPs 1 and 2 also has an e-mail sending function. The digital MFPs 1 and 2 are connected with the PSTN 8 and respectively with the networks 9 and 10. The networks 9 and 10 are also connected with the Internet (not illustrated). The digital MFPs 1 and 2 can send and receive e-mail via the Internet.

FIG. 2 is a block diagram schematically illustrating a configuration of a control system of the digital MFPs 1 and 2. The digital MFP 1 includes a Central Processing Unit (CPU) 11, a Read Only Memory (ROM) 12, a Random Access Memory (RAM) 13, a display-and-control unit 14, a scanner unit 15, an image memory 16, a recorder unit 17, a codec 18, a modem 19, a Network Control Unit (NCU) 20, a network board 21, and a LAN interface (I/F) 22. The various parts are connected via a bus 23.

The CPU 11 controls the various parts of the hardware of the digital MFP 1 via the bus 23, and executes various programs based on a program stored in the ROM 12. The ROM 12 previously stores various programs necessary for an operation of the digital MFP 1 and an operational message or the like. The RAM 13 includes a Static RAM (SRAM) or the like and stores temporal data produced during an execution of a program. The RAM 13 includes an area for storing a delivery setting table 24 that stores a setting for a delivery destination in a case where a facsimile or e-mail is received.

The delivery setting table 24 is used to set a condition for deciding a delivery destination from at least one of a facsimile number of a sender and information included in the e-mail. When receiving a facsimile, it is normally difficult to identify a user of a destination. Each e-mail includes prescribed header information and a body. The header information includes “Date” indicating a date and time at which the e-mail was sent, “To” indicating the destination of the e-mail, “From” indicating a transmitter of the e-mail, and “Subject” indicating additive information such as a title of the e-mail. When the digital MFP 1 or 2 receives e-mail, the user of the destination address cannot be identified because an e-mail address dedicated for the digital MFP 1 or 2 is described in the “To” field. Therefore, information for determining the delivery destination from a caller number notification or an Integrated Services Digital Network (ISDN) subaddress sent from an exchange equipment at an arrival of a call can be set in the delivery setting table 24. Information for determining the delivery destination from a sender number that is sent as a Transmitter Subscriber Identification (TSI) signal in a facsimile procedure can be set in the setting table 24. Furthermore, information for determining the delivery destination from an F-code subaddress and a password sent in the facsimile procedure can be set in the setting table 24.

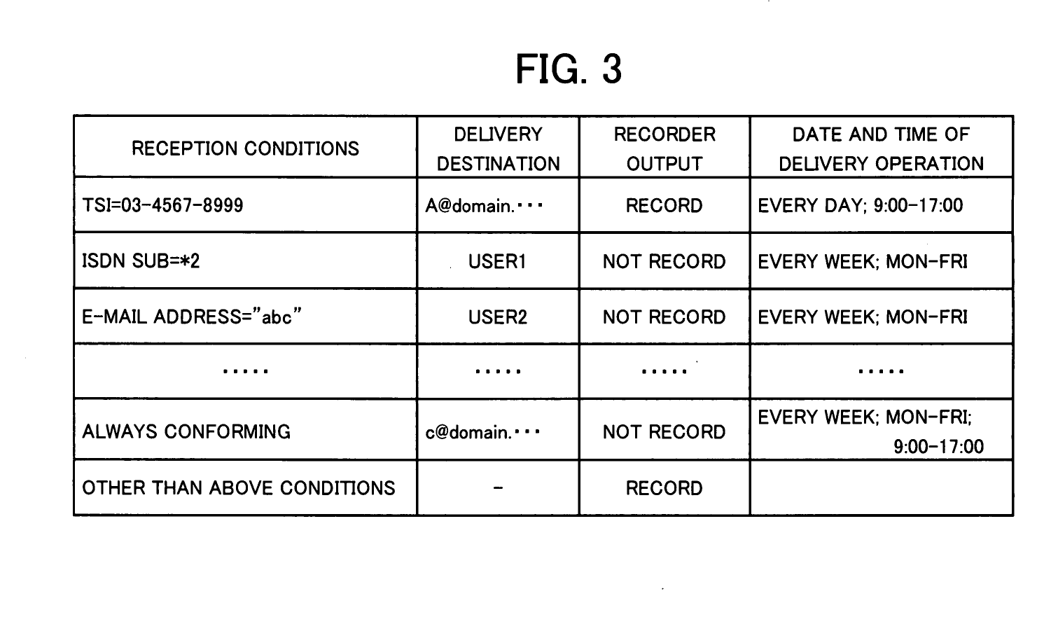

FIG. 3 illustrates one example of the delivery setting table 24. In the example illustrated in FIG. 3, when receiving a facsimile with “03-4567-8999” as a TSI during a period from 9 a.m. to 5 p.m., the facsimile is transferred to an e-mail address set as the delivery destination and is printed out. When receiving an Internet facsimile in which characters “abc” is included in an e-mail address of the sender between Monday and Friday, a content of the facsimile is saved in a folder “USER2” and is not printed out. The user can make a setting and a registration in the delivery setting table 24 by entering a requisite item either from a setting registration screen displayed on the display-and-control unit 14 or from a setting entry screen displayed on a monitor of the PC 3 or 4.

The display-and-control unit 14 includes a display portion and operation keys. The display portion displays an operational status of the digital MFP 1 or a control screen of various functions. The operation keys include numerous keys for operating the digital MFP 1. The scanner unit 15 includes at least one of an Auto Document Feeder (ADF) and a document table for a Flat Bed Scanner (FBS). The scanner unit 15 scans an original document by a scanner utilizing a Charge-Coupled Device (CCD) or the like, and outputs dot image data.

The image memory 16 includes a Dynamic RAM (DRAM) and stores image data to be transmitted, received image data, or image data scanned by the scanner unit 15. The recorder unit 17 includes an electrophotographic printer or the like and prints out received data, copied document data, or print data transmitted from an external PC.

The codec 18 encodes and decodes image data in accordance with a given protocol. The codec 18 encodes image data of a scanned original document by Modified Huffman (MH), Modified Read (MR), or Modified MR (MMR) scheme to transmit the image data. The codec 18 converts image data received from the outside into a generally used image format as a file that can be attached to an e-mail. At this time, the codec 18 encodes and decodes image data received from the outside to convert the image data into an image format such as a Tagged Image File Format (TIFF).

The modem 19 is connected with the bus 23 and has a function of a facsimile modem capable of facsimile communication. The modem 19 is also connected with the NCU 20, which is connected with the bus 23. The NCU 20 is a hardware unit for making and breaking an analog network. If necessary, the NCU 20 connects the modem 19 with the PSTN 8.

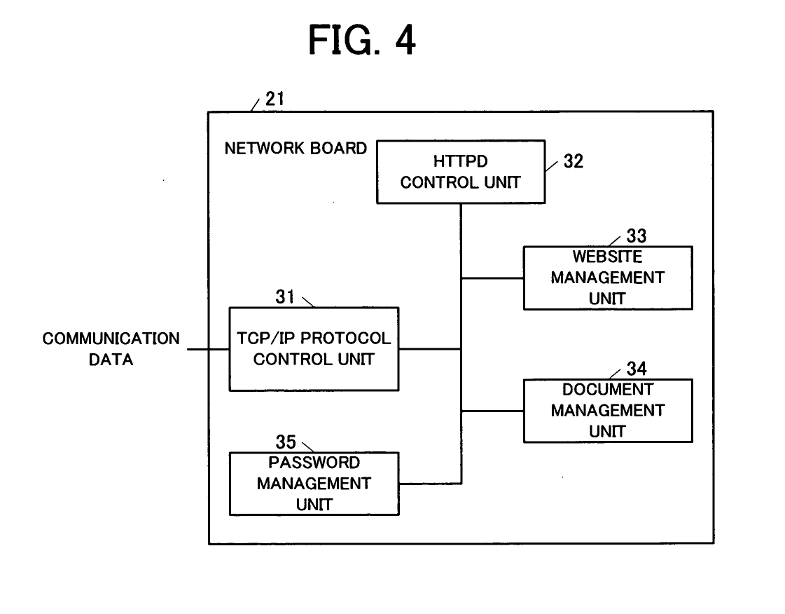

As illustrated in the functional block diagram of FIG. 4, the network board 21 includes a Transmission Control Protocol/Internet Protocol (TCP/IP) protocol control unit 31, a Hyper Text Transfer Protocol Daemon (HTTPD) control unit 32, a website management unit 33, a document management unit 34, and a password management unit 35. Each of the units of the network board 21 includes a CPU, a memory such as a ROM and a RAM, and a magnetic disk (hard disk) storage device or the like.

The TCP/IP protocol control unit 31 controls the TCP/IP. The HTTPD control unit 32 performs processing on the HTTPD function, using a data stream transfer function of the TCP/IP protocol control unit 31, and handles a request from a World Wide Web (WWW) browser of the PCs 3 and 4 or the like. Further, the HTTPD is a daemon offering a function of an HTTP server, and is used when operating a Web server on the UNIX® operating system.

The website management unit 33 outputs a website file to the HTTPD control unit 32 in response to a website request from the HTTPD control unit 32. The document management unit 34 stores documents obtained as a result of an operation performed from the digital MFP 1, such as documents transmitted by facsimile, documents obtained by scanning, and delivery documents received by facsimile and/or e-mail. The document management unit 34 converts information of a list of stored documents into a file in the Hyper Text Markup Language (HTML) format in response to a request from the HTTPD control unit 32. Then, the document management unit 34 outputs the file to the HTTPD control unit 32, analyzes information entered from the HTTPD control unit 32, and processes the stored documents. For example, the document management unit 34 transfers or deletes the stored documents.

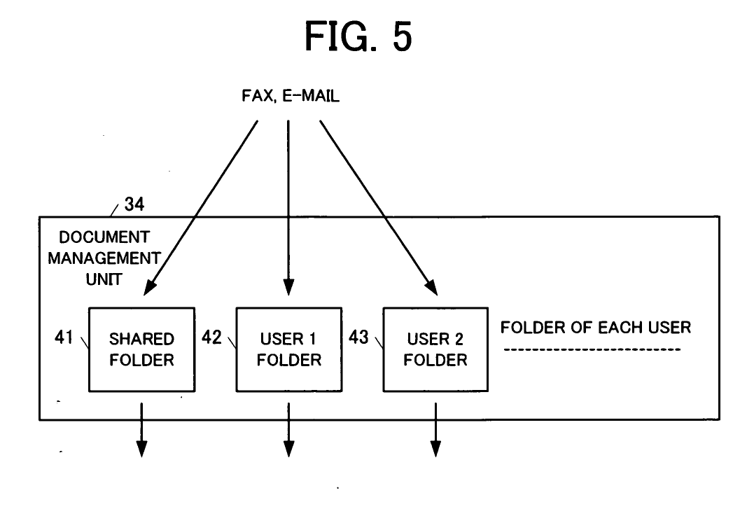

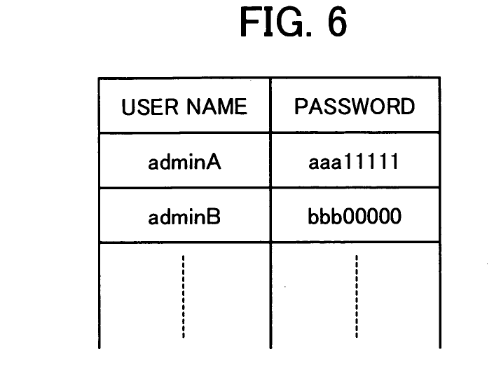

FIG. 5 schematically illustrates the document management unit 34. As illustrated in FIG. 5, the document management unit 34 has a shared folder 41 and folders 42, 43, etc. for each user. When receiving a facsimile or e-mail, the received document is stored in respective folders according to the setting in the delivery setting table 24 held in the RAM 13. The password management unit 35 stores and manages a password table storing user names and a password of the users as illustrated in FIG. 6.

The LAN interface 22 is connected with the network 9 and receives data from an external PC or data from the Internet via the network 9. The LAN interface 22 also sends data to the network 9. The LAN interface 22 executes interface processing including data conversion and protocol conversion.

The digital MFPs 1 and 2 are constructed as described above. During facsimile transmission, image data of an original document is scanned by the scanner unit 15. The scanned data is compressed by the codec 18 and stored in the image memory 16. The compressed image data is read from the image memory 16 and modulated by the modem 19. The modulated image data is then sent to a communicating party from the NCU 20 via the PSTN 8. During facsimile reception, if a delivery setting is not made in particular, the received image data is demodulated by the modem 19, and stored in the image memory 16. Then, the image data is decoded by the codec 18, and printed out by the recorder unit 17.

During reception of e-mail, a delivery process to a specified delivery destination is carried out according to the setting in the delivery setting table 24. That is, when receiving e-mail, received data is stored in a corresponding folder and/or the received data is printed out by the recorder unit 17 according to the setting in the delivery setting table 24. The received data is printed out when the setting in the delivery setting table 24 includes printout.

Next, a description will be made of an operation performed when viewing a document stored in each folder of the document management unit 34 as described above from the PCs 3 and 4 or the like. A user starts a WWW browser. For example, a WWW browser screen is displayed on the monitor of the PC 4. On this WWW browser screen, an IP address of the digital MFP 1 is specified to make access. This is detected by the HTTPD control unit 32 of the network board 21 of the MFP 1. A website file described in the HTML is read from the website management unit 33 and transferred to the PC 4 via the TCP/IP protocol control unit 31, the LAN interface 22, and the network 9.

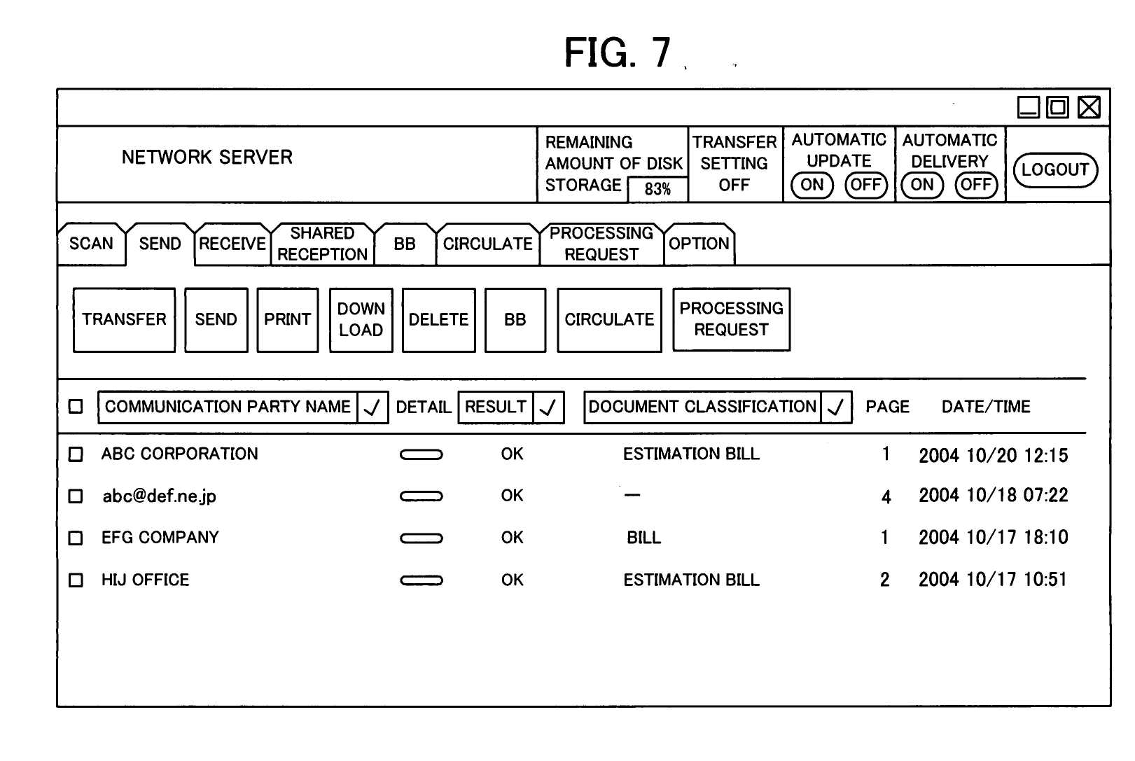

When the user selects display of a list of documents from the website and gives an instruction, the request for the display of the list is transferred to the digital MFP 1 via the network 9. This is detected by the HTTPD control unit 32 of the network board 21. Thus, the HTTPD control unit 32 instructs the document management unit 34 to transfer the list of the documents. The document management unit 34 converts information about the list of the stored documents into an HTML format file, and transfers the file to the PC 4. Consequently, the screen of the list of the documents illustrated in FIG. 7 is displayed on the monitor screen of the PC 4.

As illustrated in FIG. 7, switching tags and function selecting buttons are displayed at the top of the screen of the list of documents. The switching tags include switching tags for scanned image, transmitted document, received document, received shared document, bulletin board (BB), circulated document, processing request document, and an option. The function selecting buttons include function selecting buttons for “transfer”, “send”, “print”, “download”, “delete”, “BB”, “circulate”, and “processing request”. In the case of a transmitted document, a communication party name, a transmission result, a document classification, a number of pages, and date and time of transmission, or the like are displayed at a lower portion of the screen of the list of documents. The user can display a document of a desired document classification by selecting the document switching tag from the screen. Furthermore, the user can download a specified document by clicking the function selecting button “download” after specifying the displayed document. The contents of the downloaded document can be confirmed using application software in the PC, or the downloaded document can be printed out.

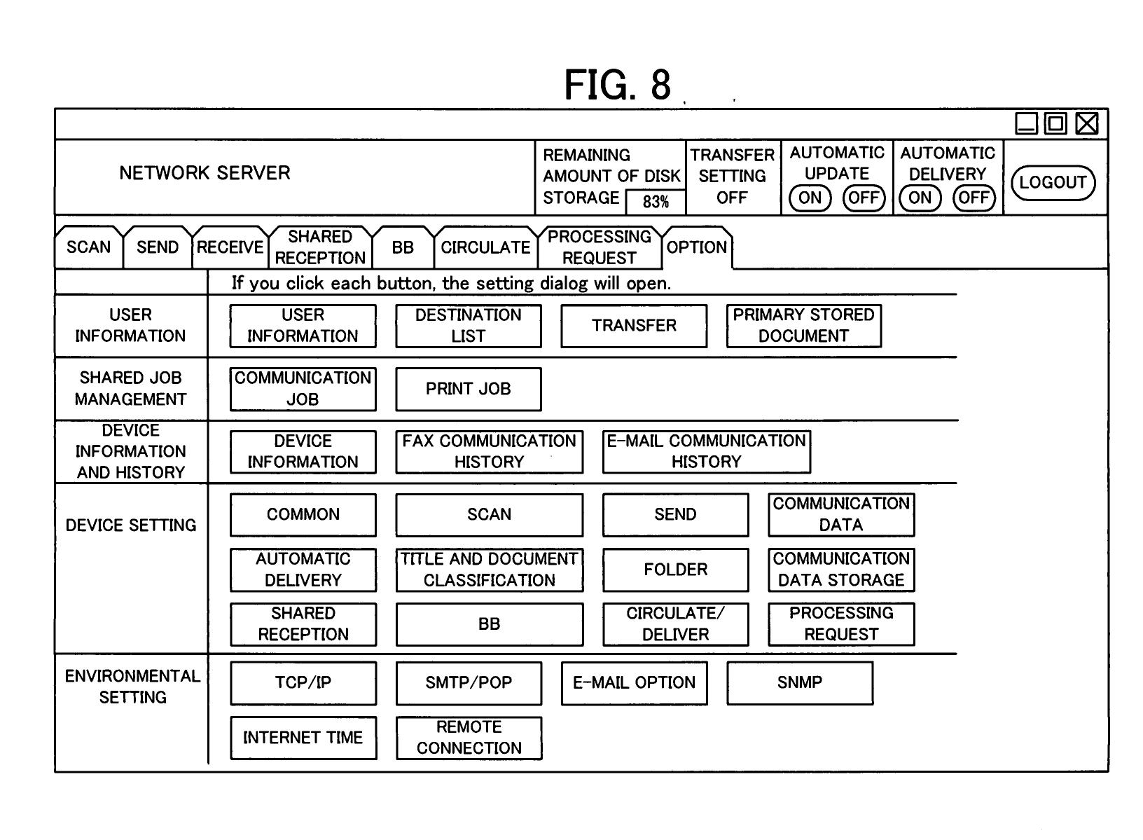

The switching tag “option” on the screen of FIG. 7 is used for making various settings in the digital MFP 1 or for confirming information. When the user clicks the switching tag “option”, an optional function selection screen as illustrated in FIG. 8 is displayed on the monitor screen of the PC. From the selection screen, the user can select and set “user information” as user information, “destination list” as a telephone directory and “transfer” function or the like. The user can select and set a “communication job” function and a “print job” function as a shared job management. The user can browse “device information”, “fax communication history”, and “e-mail communication history” as device information and history. As the device setting, the user can select and set various functions including “common”, “scan”, “send”, “communication data”, “automatic delivery”, “title and document classification”, “folder”, “communication data storage”, “shared reception”, “BB”, “circulate/deliver”, and “processing request”. In addition, in environmental settings, the user can select and set various environmental settings such as “TCP/IP”, “e-mail option”, and “remote connection”.

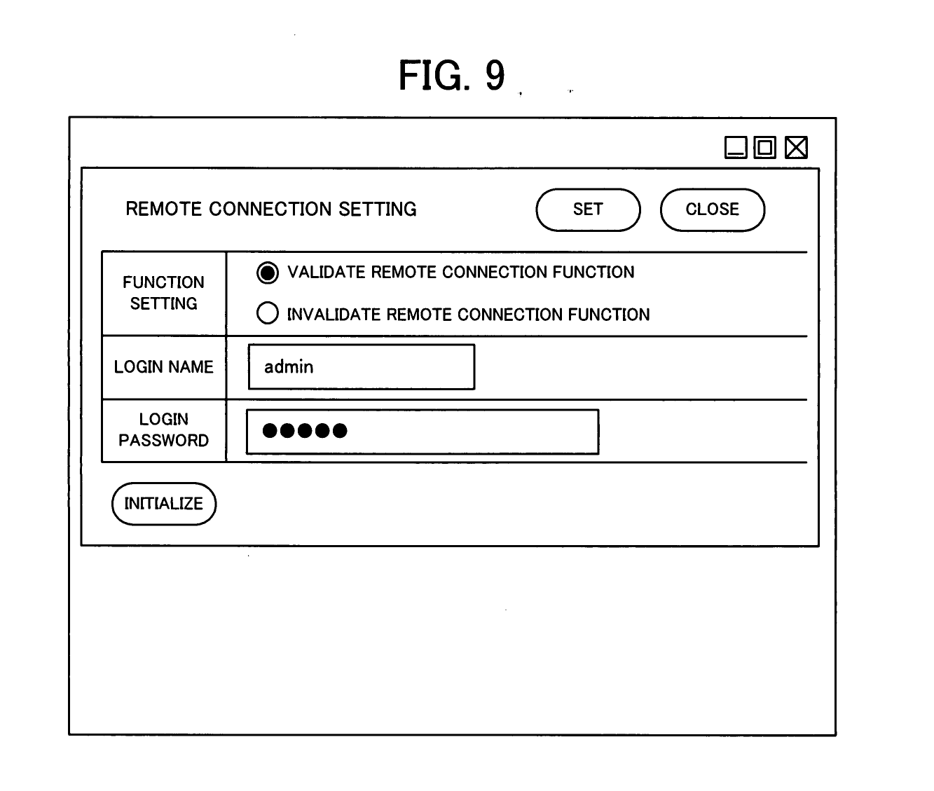

When an administrator clicks “remote connection” in the optional function selection screen as illustrated in FIG. 8, a remote connection setting screen as illustrated in FIG. 9 is displayed. That is, when a remote connection setting request is sent to the digital MFP 1 from the PC 3, data of the remote connection setting screen is transmitted from the digital MFP 1 to the PC 3. Then, the remote connection setting screen is displayed on the PC 3. In this screen, a setting is made as to whether or not to validate a remote connection function. The remote connection setting screen includes entry fields for entering a login name and a login password (a password for registration). After entering the login name and the login password, when the remote connection function is validated and a “set” button is clicked, the login name and the login password are sent to the password management unit 35 of the network board 21 and stored in the password management unit 35. After the login name and the login password or the like are stored in the password management unit 35, when one of function buttons is clicked on the optional function selection screen of FIG. 8, a password is requested to be entered.

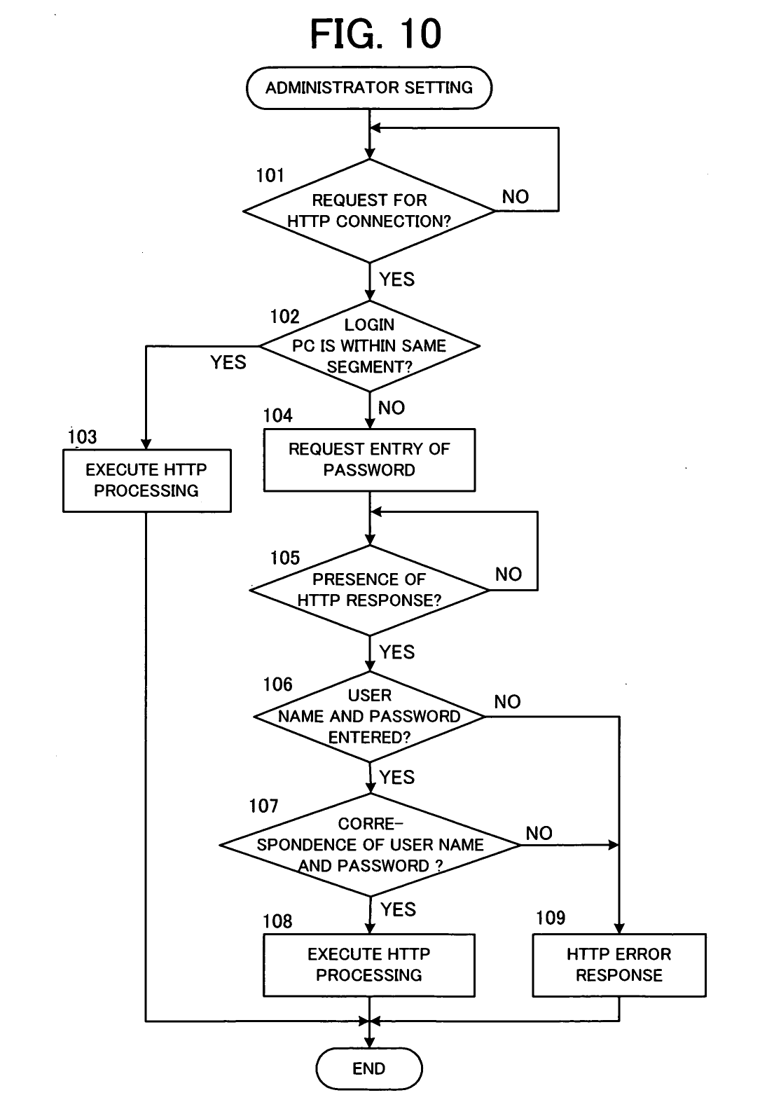

Next, by referring to the flowchart of FIG. 10, a description will be made of an operation performed when the system administrator registers or alters a setting of the digital MFP 1 from the PC 3. The HTTPD control unit 32 of the network board 21 constantly executes a program illustrated in the flowchart of FIG. 10 to determine whether the PC 3, 4, or the like has made a request for an HTTP connection to the IP address of the digital MFP 1 (step 101).

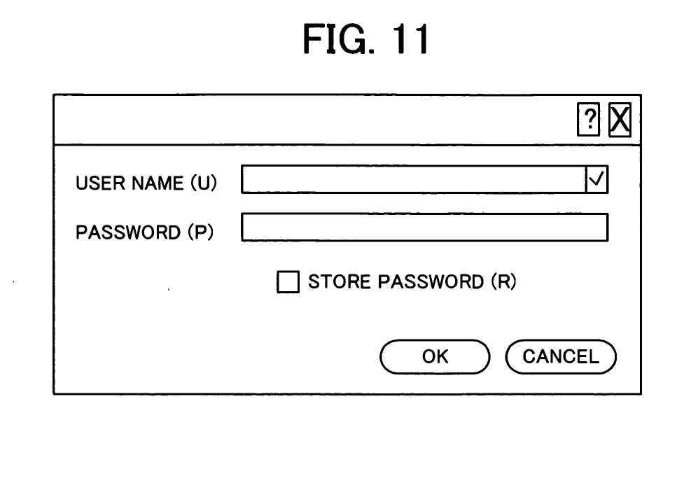

When the system administrator clicks a button in the option selection screen of FIG. 8 displayed on the monitor screen of the PC 3, i.e., when the PC 3 makes a login request, the HTTPD control unit 32 of the network board 21 detects the login request and determines whether or not the login PC is within the same segment (step 102). When a determination is made that the login PC is within the same segment (step 102: Yes), the HTTPD control unit 32 executes the requested HTTP processing (step 103). When a determination is made at step 102 that the login PC is not within the same segment (step 102: No), the HTTPD control unit 32 makes a request for an entry of a password by displaying a password entry screen as illustrated in FIG. 11 on the monitor screen of the PC 3 (step 104).

Then, the HTTPD control unit 32 determines whether or not an HTTP response has been received from the PC 3 (step 105). When receiving an HTTP response (step 105: Yes), a determination is made as to whether or not a user name and a password have been entered (step 106). When a determination is made that the user name and the password have been entered (step 106: Yes), the HTTPD control unit 32 determines whether or not the entered user name and the password correspond with a user name and a password stored in the password management unit 35 (step 107). When a determination is made that the entered user name and the password correspond with those stored in the password management unit 35 (step 107: Yes), the requested HTTP processing is carried out (step 108). When a determination is made at step 106 that the user name and the password have not been entered (step 106: No) or when a determination is made at step 107 that the entered user name and the password do not correspond with those stored in the password management unit 35 (step 107: No), the HTTPD control unit 32 returns an HTTP error response (step 109).

As described above, a password is not requested to be entered when an access is made from a terminal device within the same segment where the digital MFP is located. However, a password is requested to be entered when an access is made from a terminal device outside the same segment. In addition, a determination is carried out as to whether or not the entered password corresponds with the password registered in the digital MFP. Consequently, security can be guaranteed by simple authentication management.

### Second Preferred Embodiment

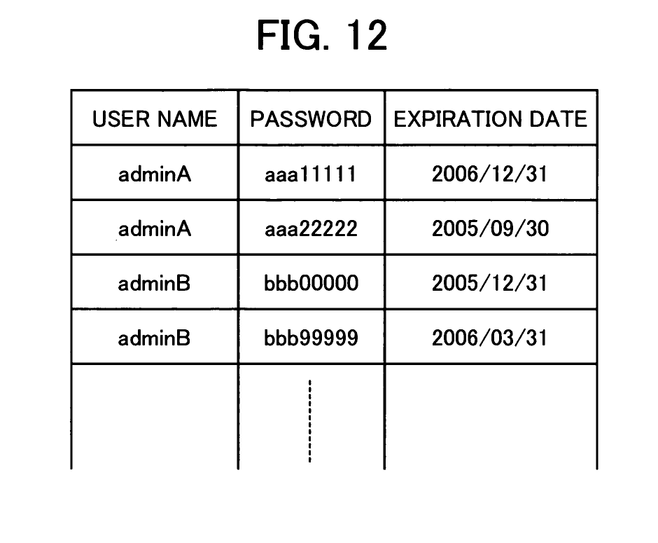

In the first preferred embodiment described above, a determination is simply carried out as to whether the entered user name and the password correspond with those stored in the digital MFP. In the following, a description will be made of a second preferred embodiment in which a plurality of passwords may be registered and an expiration date is set for each password to improve security. The structure of the digital MFP 1 is the same as the structure already described in connection with FIGS. 1-5 except that a password table stored in the password management unit 35 of the network board 21 is different. Therefore, a detailed description is omitted. FIG. 12 illustrates one example of the password table according to the second preferred embodiment. As illustrated in FIG. 12, the user can register a plurality of passwords. It is possible to set an expiration date for each individual password.

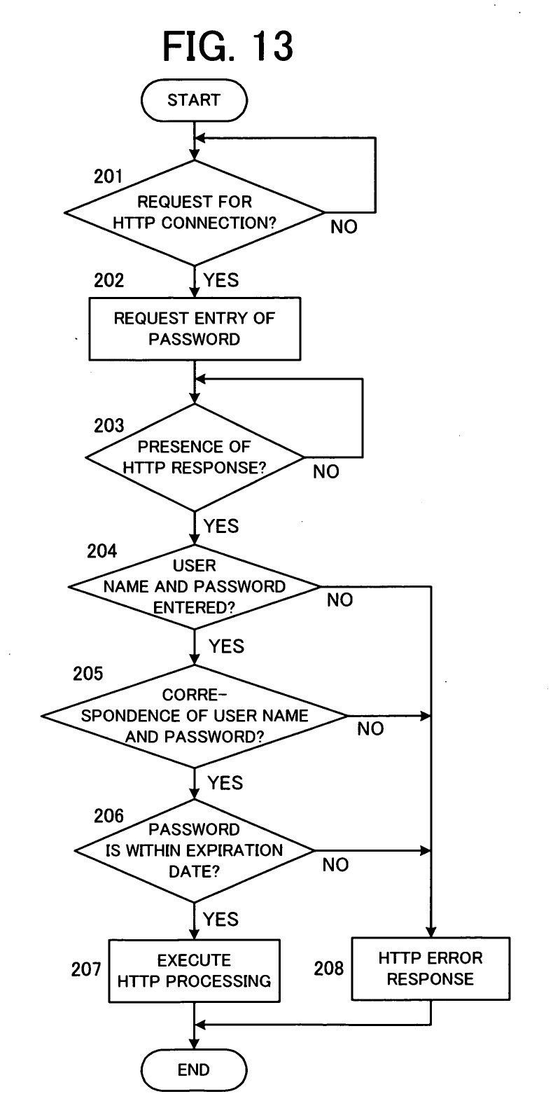

By referring to the flowchart of FIG. 13, a description will be made of the operation performed when the system administrator registers or alters a setting in the digital MFP 1 from the PC 3 according to the second preferred embodiment. The HTTPD control unit 32 of the network board 21 constantly executes a program illustrated in the flowchart of FIG. 13 to determine whether or not an HTTP connection request has been made to the IP address of the digital MFP 1 from the PC 3, 4, or the like (step 201).

When the system administrator clicks any button on the option selection screen (FIG. 8) displayed on the monitor screen of the PC 3, i.e., when there is a request for login from the PC 3, the HTTPD control unit 32 of the network board 21 detects the login request and displays a password entry screen on the monitor screen of the PC 3, prompting an entry of the password (step 202).

Then, the HTTPD control unit 32 determines whether or not the PC 3 has made an HTTP response (step 203). When receiving an HTTP response (step 203: Yes), a determination is made as to whether or not a user name and a password have been entered (step 204). When a determination is made that the user name and the password have been entered (step 204: Yes), the HTTPD control unit 32 determines whether or not the entered user name and the password correspond with a user name and a password stored in the password management unit 35 (step 205). When a determination is made that the entered user name and the password correspond with those stored in the password management unit 35 (step 205: Yes), a determination is made as to whether or not the password has expired (step 206). When a determination is made that the password has not expired (step 206: Yes) the HTTP processing requested by the system administrator is executed (step 207).

On the other hand, when a determination is made at step 204 that at least one of the user name and the password has not been entered (step 204: No), or when a determination is made at step 205 that at least one of the user name and the password does not correspond with the user name and the password stored in the password management unit 35 (step 205: No), or when a determination is made at step 206 that the password has expired (step 206: No), the HTTPD control unit 32 makes an HTTP error response (step 208). As described above, since any access made with an expired password is invalidated, even when the password has become known to a third party, access can be inhibited after an expiration of the password. Consequently, the security can be enhanced.

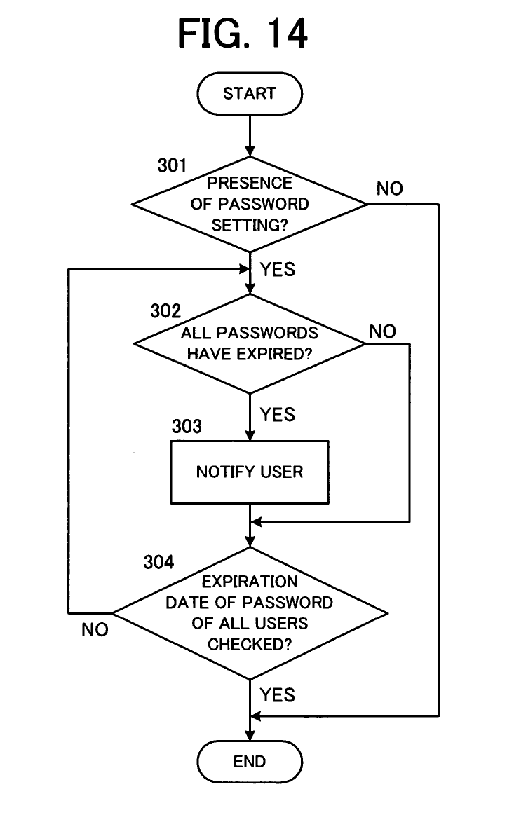

On the other hand, when the password is set to have an expiration date as described above, in case all passwords expire, the system administrator fails to execute a processing even if the system administrator enters a password. Therefore, it is desired to give a notice of the expiration to the system administrator or a user. By referring to the flowchart of FIG. 14, a description will be made of the operation of the HTTPD control unit 32 performed when notifying the expiration of the password.

The HTTPD control unit 32 of the network board 21 executes a program illustrated in the flowchart of FIG. 14 at regular intervals, for example, every 24 hours. When this program is started, a determination is made as to whether or not a password is stored in the password management unit 35 (step 301). When a password is not stored (step 301: No), the program is ended. When a determination is made that a password is stored (step 301: Yes), a determination is made as to whether or not all passwords of a specific user have expired (step 302).

When a determination is made that all the passwords have expired (step 302: Yes), the HTTPD control unit 32 gives a notice of the expiration to the system administrator or the user using an e-mail or the like (step 303). When the expiration is notified (step 303) or when a determination is made at step 302 that there is an unexpired password (step 302: No), the HTTPD control unit 32 determines whether or not the expiration date of the password of all users has been checked (step 304). When there is any user having an unchecked expiration date, the expiration date of the password of the next user is checked (step 302). When a determination is made that the expiration date of the password of all the users has been checked, the program is ended.

When all the passwords have expired, a notification of the expiration is given to the system administrator or the user as described above. Therefore, the system administrator or the user can easily recognize that a new password should be set.

The above-described second preferred embodiment can be applied to a system in which an entry of a password is not requested for an access from a terminal device within the same segment, and in which an entry of a password is requested for an access from a terminal device located outside the same segment. The second preferred embodiment can also be applied to a system in which an entry of a password is requested also for an access from a terminal device within the same segment.

In the above-described preferred embodiments, the facsimile server according to the present invention is applied to a digital MFP as an example. The facsimile server according to the present invention can also be applied to a facsimile machine or an e-mail server having neither a copy function nor a PC print function.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A facsimile server comprising:
means for establishing a connection with a terminal device via a communication network; and
means for controlling, when a login is made from the terminal device, not to perform a password authentication when the login is made from a terminal device located within a same segment as the facsimile server, and to perform the password authentication when the login is made from a terminal device located outside the same segment.

2. The facsimile server according to claim 1, wherein when the login is made from the terminal device, in case of the login from the terminal device located within the same segment, said means for controlling carries out a processing requested by the terminal device without requesting the terminal device to enter a password, and in case of the login from the terminal device located outside the same segment, said means for controlling requests the terminal device to enter a password, performs a password authentication using the entered password, and then carries out a processing requested by the terminal device.

3. The facsimile server according to claim 1, further comprising:
means for receiving a facsimile;
means for storing a delivery setting table in which a condition for deciding a delivery destination from information received by the facsimile is set; and
means for delivering a received document to the delivery destination decided by referring to the delivery setting table via the communication network.

4. The facsimile server according to claim 1, further comprising:
means for receiving e-mail;
means for storing a delivery setting table in which a condition for deciding a delivery destination from information contained in the received e-mail is set; and
means for delivering the received e-mail to the delivery destination decided by referring to the delivery setting table.

5. The facsimile server according to claim 1, further comprising:
means for storing a password; and
means for controlling to store a password received from the terminal device via the communication network into the means for storing the password.

6. A facsimile server comprising:
means for establishing a connection with a terminal device via a communication network;
means for storing a password and an expiration date of the password; and
means for controlling, when a login is made from the terminal device, to invalidate any expired password.

7. The facsimile server according to claim 6, wherein when the login is made from the terminal device, the means for controlling requests the terminal device to enter a password, and when the entered password has not expired, the means for controlling carries out a processing requested by the terminal device, and when the entered password has expired, the means for controlling makes an error response to the terminal device.

8. The facsimile server according to claim 6, wherein the means for storing the password stores user IDs, passwords, and an expiration date of the passwords.

9. The facsimile server according to claim 8, wherein the means for storing the password stores a plurality of passwords per user ID as well as the expiration date of each of the passwords.

10. The facsimile server according to claim 8, wherein the means for controlling determines whether the passwords stored in the means for storing the password have expired, and when all of the passwords for one user ID have expired, the means for controlling issues a notice of the expiration.

11. The facsimile server according to claim 10, wherein when all of the passwords for one user ID have expired, the means for controlling gives a notice of the expiration to one of an administrator and a user having said user ID.

12. The facsimile server according to claim 10, wherein the means for controlling periodically determines whether the passwords have expired.

13. The facsimile server according to claim 12, wherein the means for controlling sequentially determines whether the passwords have expired per user ID for the plurality of the user IDs.

14. The facsimile server according to claim 6, further comprising:
means for receiving a facsimile;
means for storing a delivery setting table in which a condition for deciding a delivery destination from information received by the facsimile is set; and
means for delivering a received document to the delivery destination decided by referring to the delivery setting table via the communication network.

15. The facsimile server according to claim 6, further comprising:
means for receiving e-mail;
means for storing a delivery setting table in which a condition for deciding a delivery destination from information contained in the received e-mail is set; and
means for delivering the received e-mail to the delivery destination decided by referring to the delivery setting table.

16. The facsimile server according to claim 6, further comprising means for controlling to store a password received from the terminal device via the communication network into means for storing the password.

17. A method of controlling a facsimile server, comprising the steps of:
accepting a login from a terminal device via a communication network;
determining, when accepting the login from the terminal device at the login accepting step, as to whether the login is made from the terminal device located within a same segment as the facsimile server; and
carrying out processing requested by the terminal device without performing a password authentication when a determination is made at the determining step that the login is made from the terminal device located within the same segment, and carrying out the processing requested by the terminal device after performing the password authentication when a determination is made at the determining step that the login is made from the terminal device located outside of the same segment.

18. The method of controlling a facsimile server according to claim 17, further comprising the steps of:
accepting a request of a password registration screen from the terminal device via the communication network;
sending data of the password registration screen to the terminal device via the communication network in response to the request accepted at the accepting step;
receiving a password for registration from the terminal device via the communication network after sending the data of the password registration screen to the terminal device at the sending step; and
storing the password received at the receiving step in means for storing the password.

19. A method of controlling a facsimile server, comprising the steps of:
accepting a login from a terminal device via a communication network; and
invalidating an expired password when accepting the login from the terminal device at the accepting step.

20. The method of controlling a facsimile server according to claim 19, wherein the invalidating step comprises the steps of:
requesting the terminal device to enter a password when accepting the login from the terminal device at the accepting step;
making a first determination as to whether the password received from the terminal device has expired after requesting the entry of the password at the requesting step; and
making an error response to the terminal device when a determination is made that the password has expired.

21. The method of controlling a facsimile server according to claim 19, further comprising the steps of:
making a second determination as to whether all passwords for one user ID have expired; and
issuing a notice of the expiration when a determination is made that all the passwords for one user ID have expired.

22. The method of controlling a facsimile server according to claim 21, wherein the second determination is made periodically.

23. The method of controlling a facsimile server according to claim 21, wherein at the step of making the second determination, the determination is made sequentially as to whether the passwords have expired per user ID for a plurality of user IDs.
